(19) United States
(12) Patent Application Publication
(10) Pub. No.: US 2014/0267752 A1
(43) Pub. Date: Sep. 18, 2014

(54) CLOUD TECHNOLOGY SURVEILLANCE

(71) Applicant: Jingle Huang, LAS VEGAS, NV (US)

(72) Inventor: Jingle Huang, LAS VEGAS, NV (US)

(21) Appl. No.: 14/287,571

(22) Filed: May 27, 2014

Related U.S. Application Data
(63) Continuation-in-part of application No. 13/424,227, filed on Mar. 19, 2012.

(51) Int. Cl. G08B 13/196; H04N 5/247; H04N 7/18

(52) U.S. Cl. CPC G08B 13/19656; H04N 7/181; H04N 5/247
USPC 348/159

(57) ABSTRACT

A cloud technology surveillance system features a low cost partial installation option that can still provide high security, no end user configuration and a video monitoring service. The cloud technology surveillance system includes a virtual surveillance recorders server and a large number of wireless IP camera packages. The camera packages capture and send the images to the server. The virtual surveillance recorder stores the images and provides viewers to access them. Large numbers of virtual recorders are grouped into a virtual private server that is located in the Internet cloud. A monitoring service provider can access the virtual private server and provide the monitoring service to the customers in accordance with customer agreements.

The present invention is a continuation in part (CIP) of and claims priority from non-provisional parent application having U.S. patent application Ser. No. 13/424,227 by same inventor Jingle Huang entitled Cloud Technology Surveillance System filed Mar. 19, 2012, the disclosure of which is incorporated herein by reference.

### BACKGROUND OF THE INVENTION

Surveillance systems have been used widely in offices, banks, stores, and restaurants, have not been available as a household appliance because of its high cost and complex configuration. Currently the Internet is very widespread, and using the Internet for monitoring is a common solution. However, the Internet is a digital network and most of the surveillance systems are adapted from analog signal surveillance. Also, most surveillance systems are not fully compatible with the Internet.

A significant drawback of the traditional surveillance is the security of the video recorder. The video recorder is traditionally located in the same building as the cameras, so if it can be found, it can be destroyed easily. Another significant drawback of the traditional surveillance is that different owners cannot control a single service provider's equipment to provide a video monitoring service. Configuring the video network is also another major problem. Non-technical persons have difficulty when configuring video networks. A main object of the present invention is to provide a video surveillance system that does not require a user to configure the network.

### SUMMARY OF THE INVENTION

In one embodiment, the present invention comprises an Internet cloud technology surveillance system with a large number of wireless IP camera packages and virtual recorders. A virtual recorder has a cloud storage to store video and images from IP cameras and a web server to provide the functions of authentication, searching, browsing of images for viewers and an organizer for images. A wireless camera package includes one surveillance router and at least one wireless IP camera with all parts is completed configured. To lower the expense of the system, all virtual recorders are grouped into a virtual private server. On the other hand, the Internet cloud technology raises the security level of this surveillance system. Additionally, this system includes a monitoring service provider, which can provide a monitoring service to end user customers.

A cloud technology surveillance system features a low cost partial installation option that can still provide high security, no end user configuration and a video monitoring service. The cloud technology surveillance system includes a virtual surveillance recorders server and a large number of wireless IP camera packages. The camera packages capture and send the images to the server. The virtual surveillance recorder stores the images and provides viewers to access them. Large numbers of virtual recorders are grouped into a virtual private server that is located in the Internet cloud. A monitoring service provider can access the virtual private server and provide the monitoring service to the customers in accordance with customer agreements.

A surveillance system has a large number of cameras with at least 100 camera packages, a video monitoring service provider and a virtual surveillance recorder server located on an Internet cloud storage. The cloud storage is configured to receive images from the camera packages. A domain name can be used by the camera packages to connect to the cloud storage. The surveillance system also has one or more wireless IP cameras for capturing images, and a CTS router for switching the image from the wireless IP camera to the virtual video surveillance recorder. A camera package includes a wireless IP camera that has a WiFi wireless connection to connect to a CTS router. A camera package may also have all settings including WiFi SSID, WiFi password of the CTS router and the wireless IP camera completed preconfigured. The camera package can be configured to work with a virtual video surveillance recorder. The virtual surveillance recorders server is a virtual private server that is grouped together with other virtual video surveillance recorders.

The virtual video surveillance recorder remains in the Internet cloud and includes a cloud storage, an image organizer and a web server. The web server provides functions of authentication, searching and browsing for viewers. The organizer retrieves the images from cloud storage, organizes and stores images to web server's storage. The web server has at least one domain name used by viewers. The web server has an image storage, an authentication module, and an http daemon module. The image storage stores image data. The authentication module protects the image data. The http daemon module provides Internet access for viewers. Http includes https. The cloud allows the virtual video surveillance recorder to be in multiple physical locations, and have a physical data backup that is in different geographic locations.

The video monitoring service provider can be configured to check the images from the camera packages for providing the monitoring service to the customers in accordance with their agreements. The virtual surveillance recorder server has virtual processors, virtual memory and virtual storage provided by the Internet cloud resource provider. The camera package is housed as an Internet terminal device. The virtual surveillance recorder server has: virtual processors, memory, computing storage, and can have for storage a group of large number of virtual recorders in a virtual private server. The Internet image sensor terminal device has: a preconfigured wireless IP camera, and a preconfigured CTS router. The CTS router and the wireless IP camera are housed in one package.

The virtual surveillance recorder server provides video monitoring service including being configured to: receive customer agreement input, receive customer alarm activation information; receive images from the camera package when the camera package is triggered, receive check customer images from the camera package, and to include a means to notify the customer or police when the signal is not faulty.

### BRIEF DESCRIPTION OF THE DRAWINGS

FIG. 1 is the system diagram showing the hardware components used to construct a preferred embodiment of the invention.

FIG. 2 is the diagram showing two application examples of the camera package.

FIG. 3 is the diagram showing the logical components of a virtual surveillance recorder.

FIG. 4 is the diagram showing the logical components of the web server.

FIG. 5 is the diagram showing the single video surveillance system.

FIG. 6 is the diagram showing the picture of a camera package.

FIG. 7 is the diagram showing the logical components of virtual surveillance system.

The following call out list of elements can be a useful guide in referencing the elements of the drawings.
100-103 Camera Packages
104 Virtual Surveillance Recorders Server
105 Internet Cloud
106-108 Remote Viewers
109 Monitoring Service Provider
200 Camera
201 Camera
202 CTS Router
203 Surveillance Recorders Server
204 Internet Connection
205 Location
206 Camera Package
207 Cts Router
208 Package
209 Location
210 Internet Connection
300 Camera Package
302 Internet Connections
303 Viewers
304 Recorder
305 Cloud Storage
306 Image Organizer
307 Web Server
400 Web Server
401 Image Storage
402 Authentication
403 HTTP (S) Daemon
500 Wireless IP Camera
502 Cloud Technology Surveillance (CTS) Router
501 Wifi Connection
502 CTS Router
503 Virtual Recorder
504 Internet Connection
505 Package
701 Package
702 Internet Connection
703 Virtual Recorder
704 Package
705 Internet Connection
706 Virtual Recorder
707 Package
708 Internet Connection
709 Virtual Recorder
710 Virtual Surveillance Recorders Server

### DETAILED DESCRIPTION

The present invention provides a structure and method of managing a security surveillance system over the Internet using “virtual” cloud technology. The images, sound or video from wireless IP cameras can be stored and viewed or played back by web browsers. A monitoring service provider is included in this system to provide video monitoring service to customers.

FIG. 1 depicts the system hardware structure. This system includes camera packages 100-103 and a virtual surveillance recorder server 104. The term ‘package’ refers to a physical enclosure that denotes a housing, or a shipping carton that the camera is housed within, which can be a cardboard box or a plastic molded injection housing. The surveillance server 104 is located in the Internet cloud 105. Remote viewers 106-108 search and view the images stored in the server by PCs, mobile phones and other Internet terminals through their Internet connections.

In this system, the quantity of camera packages on the network is infinite in theory. In reality, the total number of cameras is limited by the image size, network bandwidth, storage volume and server's computing speed. Currently, the total possible quantity is large, meaning at least 100 cameras can be networked.

The camera is digital network camera, also called an IP camera that is preferably wireless.

The virtual surveillance recorder server is a virtual private server (VPS), not a physical machine. Its processors, memory and storage are also virtual and provided by the Internet cloud resource provider. The virtual surveillance server has at least two domain names: one used by camera packages; and the other used by viewers and the monitoring service provider.

Viewers don't need to know the physical location of the surveillance server, because they access the surveillance server via the domain names of the server. It protects the camera image data and makes the image data hard to destroy. The surveillance server's security level is much higher than the traditional surveillance video recorder.

The monitoring service provider 109 is a special viewer. The provider must have the customer's agreement before it provides the video monitoring service to the customer. After the customer turns the alarm on, when something moves into the protected area, the customer's camera is triggered and sends the captured images, sound or video to the virtual recorder. The provider can check the image and notify the customer or police after determining the triggering signal from the camera is not faulty.

FIG. 5 is a diagram of the single video surveillance system. Wireless IP camera 500 connects to Cloud Technology Surveillance (CTS) router 502 by WiFi connection 501. CTS router 502 connects to virtual surveillance video recorder 503 via an Internet connection 504. Wireless IP camera 500 and CTS router 502 are grouped into the package 505. Package 505 and virtual recorder 503 constitute a completed single video surveillance system.

Package 505 includes one CTS router and one or more wireless IP cameras. The package constitutes a basic Internet image sensor terminal device of the cloud surveillance system. Being Internet terminal devices, the camera packages are packaged as merchandise which can be sold separately to different people.

Recorder 503 stays in the Internet cloud and is maintained by the system technicians. Without the maintenance of surveillance recorder, the owner of the camera package can keep the system working easily.

In package 505, all settings in the wireless IP camera and CTS router, including SSID and wireless password, are completed configured. It means that the wireless IP camera cannot work without the CTS router and the camera package owners don't need to do any configuration.

FIG. 6 is the diagram showing the picture of a camera package. This package includes one wireless IP camera and one CTS router. The user can simply plug in the system to install it.

FIG. 3 is a diagram showing the logical components of a virtual surveillance recorder. Three parts combine the recorder 304, namely: the cloud storage 305, the image organizer 306 and the web server 307.

The cloud storage 305 receives images from the camera package 300. It has a domain name which is used by the camera package.

The image organizer 306 retrieves images from the cloud storage 305, organizes and moves them to the web server 307.

The web server 307 has a domain name that is used by viewers 303. Viewers access the web server through the Internet connections 302 and search, browse the images. FIG. 4 shows the logical parts of the web server. The web server 400 is made of image storage 401, authentication 402 and http(s) daemon 403.

The image storage 401 is a high capacity storage. It stores the images from the camera package and archives them for long-term storage. The authentication component 402 provides a password authentication for the image data that stored in the storage 401 to avoid the illegal access. The http(s) daemon component 403 provides the Internet access for viewers.

FIG. 7 is the diagram showing the logical components of the virtual surveillance system. Package 701 connects to virtual recorder 703 via Internet connection 702. Package 704 connects to virtual recorder 706 via Internet connection 705. Package 707 connects to virtual recorder 709 via Internet connection 708. All virtual recorders are grouped into a virtual surveillance recorders server 710. This server is also a virtual private server (VPS).

In the logical layer, the image data in different recorders are stored in different storages and protected by different passwords. The viewer who can view the image in one recorder cannot view the image in another recorder without authentication.

FIG. 2 depicts two application examples of the camera package. Camera 200, camera 201 and CTS router 202 are grouped into camera package 206 and the package is placed in location 205. Camera 206 and CTS router 207 are grouped into package 208 and the package is placed in location 209. The camera 200 and camera 201 connect to CTS router 202. CTS router 202 connects to the surveillance recorders server 203 through Internet connection 204. Cameras 206 connect to CTS router 207. CTS router 207 connects to the surveillance server 203 through Internet connection 210.

As shown in FIG. 2, camera packages that connect to the same surveillance server can be placed in different locations. All packages use a domain name of the server to send their images.

As shown in FIG. 2, camera package can be placed in the different location from the surveillance server.

Because the camera package owners don't need to pay for a fully complete surveillance system, they can own the camera package and have full video surveillance function at a lower cost.

1. A surveillance system, comprising:
a. camera packages, wherein there are at least 100 camera packages;
b. a video monitoring service provider; and
c. a virtual surveillance recorder server located in an Internet cloud storage, wherein the cloud storage is configured to receive images from the camera packages, wherein the virtual surveillance recorders server is a virtual private server that is grouped together with other virtual video surveillance recorders so that it serves the camera packages.

2. The surveillance system of claim 1, further comprising: one or more wireless IP cameras for capturing images; and a CTS router for switching the image from the wireless IP camera to the virtual video surveillance recorder.

3. The surveillance system of claim 2, further comprising a camera package, wherein the CTS router and the wireless IP camera are connected with WiFi wireless connection.

4. The surveillance system of claim 2, further comprising a camera package, wherein all settings including WiFi SSID, WiFi password of the CTS router and the wireless IP camera are completed preconfigured.

5. The surveillance system of claim 1, further comprising: a domain name used by the camera packages to connect to the cloud storage.

6. The surveillance system of claim 5, wherein the virtual video surveillance recorder remains in the Internet cloud.

7. The surveillance system of claim 5, wherein the virtual video surveillance recorder includes a cloud storage, an image organizer and a web server.

8. The surveillance system of claim 7, wherein the web server provides functions of authentication, searching and browsing for viewers.

9. The surveillance system of claim 7, wherein the organizer retrieves the images from cloud storage, organizes and stores images to web server's storage.

10. The surveillance system of claim 7, wherein the web server has at least one domain name used by viewers.

11. The surveillance system of claim 7, wherein the web server has an image storage; an authentication module; and an http daemon module.

12. The surveillance system of claim 11, wherein the image storage stores image data.

13. The surveillance system of claim 11, wherein the authentication module protects the image data.

14. The surveillance system of claim 11, wherein the http daemon module provides the Internet access for viewers.

15. The surveillance system of claim 1, further comprising a video monitoring service provider, configured to check the images from the camera packages for providing the monitoring service to the customers in accordance with their agreements.

16. The surveillance system of claim 1, wherein the virtual surveillance recorder server has the virtual processors, virtual memory and virtual storage provided by the Internet cloud resource provider.

17. The surveillance system of claim 1, wherein the camera package is housed as an Internet terminal device.

18. The surveillance system of claim 1, wherein the virtual surveillance recorder server further includes: the virtual processors, memory, computing storage, storing; grouping large number of virtual recorders into a virtual private server.

19. The surveillance system of claim 1, further comprising an Internet image sensor terminal device that includes: a preconfigured wireless IP camera; and a preconfigured CTS router, wherein the CTS router and the wireless IP camera are housed in one package.

20. The surveillance system of claim 1, wherein the virtual surveillance recorder server provides video monitoring service including being configured to: receive customer agreement input; customer alarm activation information; receive images from the camera package when the camera package is triggered; check customer images from the camera package; include a means to notify the customer or police when the signal is not faulty.
